(19) United States
(12) Patent Application Publication
(10) Pub. No.: US 2017/0356160 A1
(43) Pub. Date: Dec. 14, 2017

(54) Tiller Back Blade Attachment

(71) Applicant: Dureen D. Reed, Nicholasville, KY (US)

(72) Inventor: Dureen D. Reed, Nicholasville, KY (US)

(21) Appl. No.: 15/182,158

(22) Filed: Jun. 14, 2016

(51) Int. Cl. E02F 3/76; A01B 33/02; E02F 3/815; A01B 49/02

(52) U.S. Cl. CPC E02F 3/7604; A01B 49/022; A01B 33/028; E02F 3/815

(57) ABSTRACT

the apparatus was made too move and level dirt, gravel, and other landscaping and paving materials. It utilizes a rear tine tiller, hinge apparatus, and back blade in combination. It opens if the tiller moves forward and closes in reverse. As used the present invention saves countless hours of time when compared to shoveling and leveling material manually.

### BACKGROUND OF THE INVENTION

It can take hours of backbreaking labor to manually fill in ditches, level off bulges, and then even off the entire terrain. Some specialized pieces of equipment exist for such tasks, such as bulldozers, but it is entirely impractical for a single individual or contractor to rent such a device for smaller home or commercial jobs.

I have a tiller that seat most of the time, you till the garden and it would seat in the barn. so I build my tiller attachment and saved time and money (from renting other equipment) by moving the loose soil and gravel with the tiller.

so now it's more then just a once or twice a year piece of garden equipment.

### BRIEF SUMMARY OF THE INVENTION

The present invention moves and levels dirt, gravel, and other landscaping and paving materials. It utilizes a rear tine tiller, hinge apparatus, and back blade in combination. It opens if the tiller moves forward and closes in reverse. As used the present invention saves countless hours of time when compared to shoveling and leveling material manually. Allows for driveways and paths to be easily filled in and leveled.

### DETAILED DESCRIPTION OF INVENTION

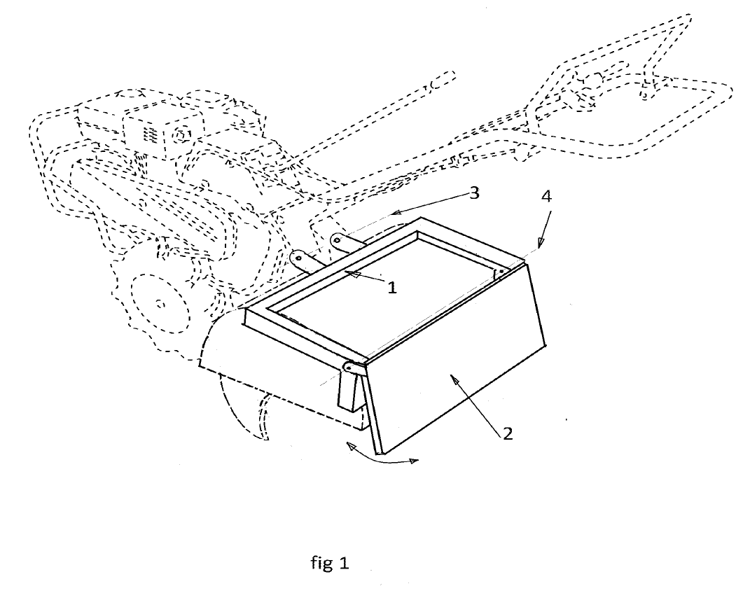

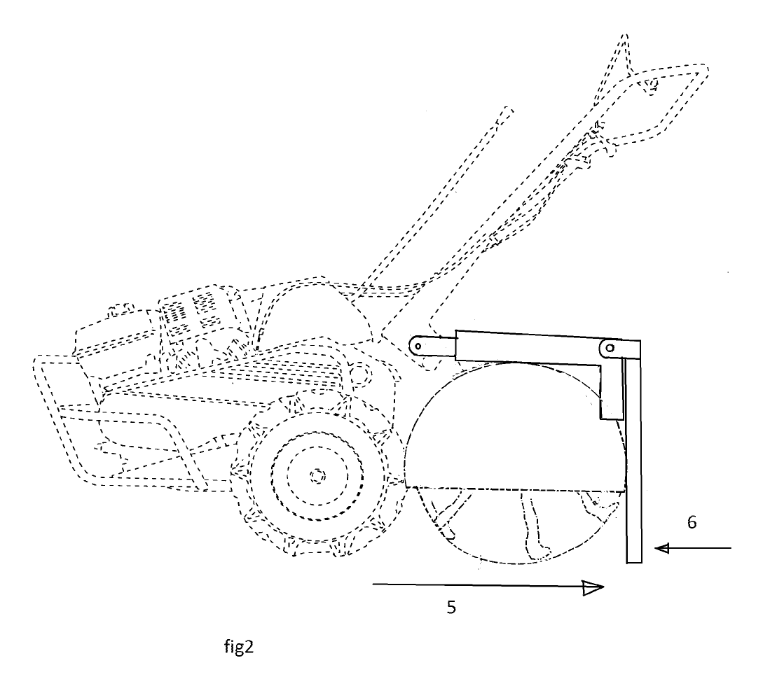

Referring now to FIGS. 1-2, Tiller Back Blade Attachment, of the present invention, comprises a tiller attachment apparatus that can be used to level dirt, gravel, and other paving materials, especially in the construction of paths and driveways. This innovative product may comprise of:

FIG. 1-1 a welded steel tubing frame or similar material,

FIG. 1-2 a blade,

FIG. 1-3 the steel frame is bolted to the back of a tiller.

FIG. 1-4 The blade is attached by bolts to the hinges and connected to the steel frame. The blade will extend downward until it touches the ground.

1- The Tiller Back Blade Attachment is a apparatus too be used to level dirt, gravel, and other paving materials, especially in the construction of paths and driveways. The Attachment may vary in size to fit various tillers. The foregoing descriptions of specific embodiment's of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiment's with various modifications as are suited to the particular use contemplated. The exact specifications of adapters and components may vary.
